(19) United States
(12) Patent Application Publication
(10) Pub. No.: US 2019/0173859 A1
(43) Pub. Date: Jun. 6, 2019

(54) SYSTEMS AND METHODS FOR IMPLEMENTING MODULAR DIGITAL ENCRYPTION KEY MANAGEMENT SOLUTIONS

(71) Applicant: iAspire, LLC, Fairfax, VA (US)

(72) Inventors: Arash Nejadian, Fairfax, VA (US); Eric Whittleton, Fairfax, VA (US)

(73) Assignee: iAspire, LLC, Fairfax, VA (US)

(21) Appl. No.: 16/011,343

(22) Filed: Jun. 18, 2018

Related U.S. Application Data
(63) Continuation of application No. 15/244,753, filed on Aug. 23, 2016, now abandoned.
(60) Provisional application No. 62/217,133, filed on Sep. 11, 2015.

(51) Int. Cl. H04L 29/06; H04L 9/08

(52) U.S. Cl. CPC H04L 63/0464; H04L 9/083; H04L 9/0825; H04L 63/06

(57) ABSTRACT

An encryption key management apparatus receives from an authorized compute device, a raw dataset that is encrypted with at least one asymmetric encryption key. The apparatus can determine, based on the raw dataset, an identifier of a first entity associated with the raw dataset and an identifier of a second entity associated with the raw dataset. The apparatus can retrieve based on the identifier of the first entity, an asymmetric decryption key associated with the first entity. Likewise, the apparatus can retrieve, based on the identifier of the second entity, an asymmetric decryption key associated with the second entity. The apparatus can generate a decrypted raw dataset using the asymmetric decryption keys associated with the first and second entities. The apparatus can additionally use a symmetric master key to generate a symmetrically encrypted raw dataset and send the symmetrically encrypted raw dataset to the authorized compute device.

### CROSS-REFERENCE TO RELATED APPLICATION

This application is a continuation of U.S. patent application Ser. No. 15/244,753, filed on Aug. 23, 2016 and entitled “Systems and Methods for Implementing Modular Digital Encryption Key Management Solutions,” which in turn claims priority to, and the benefit of U.S. Provisional Application Ser. No. 62/217,133, filed Sep. 11, 2015 and titled “Systems and Methods for Implementing Modular Digital Key Management Solutions;” each of these applications is incorporated herein by reference in its entirety.

### BACKGROUND

The embodiments described herein relate to methods and devices for digital key management. More particularly, the embodiments described herein relate to devices and methods for automating encryption key recovery processes through connecting to accountable identity sources to collect, groom, store and/or use encryption key information.

Existing privileged user access to private encryption keys for persons and non-person-entities (NPEs) is inefficient and error-prone in some known encryption architectures and can hinder business functions that use substantially real-time access to encrypted data. Some known public cryptography products support private key recovery. Some implementations based on Certificate Management Protocol (CMP) can use standard transactions to implement key recovery. Other known products perform private key backup with nonstandard transactions. As organizations seek to leverage public cryptography to protect confidential data, the business desire to support key recovery becomes more apparent.

Thus, a need exists for devices and methods to improve access to encrypted data through private encryption key management.

### SUMMARY

According to one aspect of the presently disclosed subject matter an encryption key management apparatus is provided. The apparatus includes one or more processors and a memory. The memory includes instructions, which are executed by the one or more processors. The instructions include code to: receive, from an authorized compute device, a raw data set that is encrypted with at least one asymmetric encryption key; determine, based on the raw dataset, an identifier of a first entity associated with the raw dataset and an identifier of a second entity associated with the raw dataset; retrieve, based on the identifier of the first entity, an asymmetric decryption key associated with the first entity; retrieve, based on the identifier of the second entity, an asymmetric decryption key associated with the second entity; decrypt at least a portion of the raw dataset using the asymmetric decryption key associated with the first entity and the asymmetric decryption key associated with the second entity to generate a decrypted raw dataset; re-encrypt the decrypted raw dataset using a symmetric master key to generate a symmetrically encrypted raw dataset; and send the symmetrically encrypted raw dataset to the authorized compute device.

### BRIEF DESCRIPTION OF THE DRAWINGS

FIG. 1 is a schematic block diagram of a distributed key management system, according to an embodiment.

FIG. 2 is a schematic block diagram illustrating some of the components included in one or more sub-systems of a distributed key management system, according to an embodiment.

FIG. 3 is a schematic block diagram of a key management sub-system shown in FIG. 1, according to an embodiment.

FIG. 4 is a schematic block diagram of a portion of a key management system shown in FIG. 1 illustrating key collection from a key database residing in a Certification Authority (CA) Sub-System, according to an embodiment.

FIG. 5 is a schematic block diagram of a portion of a key management system shown in FIG. 1 illustrating key collection from key stores residing in multiple User Sub-Systems, according to an embodiment.

FIG. 6 is a schematic block diagram of a portion of the key management system of FIG. 1 illustrating the decryption of Trusted Third-Party Sub-System data, according to an embodiment.

FIG. 7 is a signal flow diagram of a distributed key management system, according an embodiment.

FIG. 8 is a schematic block diagram of a system using a key management system in an eDiscovery application, according to an embodiment.

FIG. 9 is a schematic block diagram of a system using a key management system in a forensics application, according to an embodiment.

### DETAILED DESCRIPTION

In some embodiments, an apparatus includes a multi-channel mechanism for secure collection, storage and/or distribution of user and device private decryption keys, significantly improving existing public key mechanisms and the operational performance of encrypted data access.

In some embodiments, an apparatus can include one or more processors and a memory operatively coupled to the one or more processors. The memory can store instructions to cause the processors to receive from an authorized compute device, a raw dataset that is encrypted with at least one asymmetric encryption key. Thereafter, the apparatus can determine, based on the raw dataset, an identifier of a first entity associated with the raw dataset and an identifier of a second entity associated with the raw dataset. The apparatus can retrieve based on the identifier of the first entity, an asymmetric decryption key associated with the first entity. Likewise, the apparatus can retrieve, based on the identifier of the second entity, an asymmetric decryption key associated with the second entity. The apparatus can generate a decrypted raw dataset using the asymmetric decryption keys associated with the first and second entities. The apparatus can additionally use a symmetric master key to generate a symmetrically encrypted raw dataset and send the symmetrically encrypted raw dataset to the authorized compute device.

In some further embodiments, a non-transitory processor-readable medium can include processor-executable instructions to cause a processor to receive, from an authorized compute device, a raw dataset encrypted with at least one asymmetric encryption key; determine, based on the raw dataset, at least one identifier of a first entity associated with the raw dataset; receive, from a first compute device, an asymmetric decryption key associated with a user of a second compute device; determine a match between the at least one identifier of the first entity and at least one identifier of the user of the second compute device; decrypt the raw dataset using the asymmetric decryption key to generate a decrypted raw dataset; re-encrypt the raw dataset using a symmetric master key to generate a symmetrically encrypted raw dataset; and send the symmetrically encrypted raw dataset to the authorized compute device.

In yet some further embodiments, a computer-implemented method can comprise receiving, at a processor of an encryption key management device, an asymmetric decryption key associated with at least one entity; receiving from an authorized compute device a raw dataset, the raw dataset encrypted with an asymmetric encryption key associated with the at least one entity; decrypting the raw dataset using the asymmetric decryption key to generate a decrypted raw dataset; re-encrypting the decrypted raw dataset using a symmetric master key to generate a symmetrically encrypted raw dataset; and sending the symmetrically encrypted raw dataset to the authorized compute device.

Key escrow and automatic key recovery of private keys used to decrypt data can be implemented by several critical and time-sensitive applications including, for example, forensics, e-discovery, content inspection and/or other applications using asymmetrical keys. An employee, for example, may encrypt data to protect the confidentiality of critical information. While it may be important and/or critical to protect this information from competitors or actors with malicious intent, the system can continue to provide the organization itself or authorized third-parties access to the data. In some instances, for example, the organization or trusted third-parties such as law enforcement agents, can access the data as long as they have access to a private key. In general, this access can be achieved directly by an employee or other trusted individual. In such instances, however, the employee's cryptographic module can fail or be lost. Even if the cryptographic module functions, an employee may leave her position or take a vacation. In such cases, the organization may not be able to timely access the encrypted data.

Obtaining a backup copy of the encryption private key for emergency access is called key recovery and the timeliness of the key recovery process directly impacts business functions that use data decryption. Key recovery services can be offered through a variety of methods, including as a value-added service supplementing existing enterprise key management services. Performance metrics related to key recovery can be significantly improved by technology, process re-engineering and/or workflow automation described herein.

Several reasons exist to implement key recovery in conjunction with a key management system including, for example, Public Key Infrastructure (PK1). First, such key management systems can distinguish between signature public and/or private keys and encryption public and/or private keys. In some instances, it is not desirable to apply key recovery to signature private keys since it would undermine non-repudiation. Second, in some instances, the protection of signature private keys can be important for the integrity of the system. If, for example, the protection in the key recovery system is weak, an adversary can simply obtain the encryption private key from the key recovery system and decrypt the data. In some instances, if the Certification Authority (CA) Sub-System manages the storage of the private keys in a Key Database, many of the same security features used to protect the CA can be applied to the key recovery system. This can provide an economy of scale and unified security safeguards.

The systems and methods disclosed herein can improve organizations' identity management, encryption and performance management capabilities, and result in timely access to encrypted data. The systems and methods described herein can, for example, create and/or define a privileged user account, can connect to accountable identity stores for person and/or non-person-entities within a security domain, and/or can securely collect private encryption keys. Additionally, in some instances, such systems and methods can, for example, organize the private encryption keys for contextual relevance (e.g., usage frequency, historic analysis, etc.) and/or can securely store the private encryption keys in Federal Information Processing Standard (FIPS) 140-2-compliant Hardware Security Modules (HSMs). Moreover, such systems can, for example, use the private encryption keys to decrypt data in substantially real-time, index the content, and/or re-encrypt the content using symmetric cryptography technology.

The systems and methods disclosed herein can support a wide range of cryptographic standards for person entities including, for example, Secure/Multipurpose Internet Mail Extensions (S/MIME) for secure messaging, and non-person entities (NPEs) including, for example, 1) Key Management Interoperability Protocol (KMIP) for cloud security, 2) Mobile Device Management (MDM) for mobile device security, 3) Secure Sockets Layer (SSL) for web server security, 4) Internet Protocol Security (IPSec) for Virtual Private Network (VPN) security, and/or 5) Wireless Local Area Network (WLAN) for wireless network security.

The systems and methods disclosed herein can include, for example enterprise cybersecurity capabilities such as: 1) Identity and Access management (allowing for the creation and/or definition of a privilege security account that has access to user and device private encryption keys and therefore improving identity management, credential management, authentication and authorization processes), 2) Encryption (adding new processes and leveraging existing private key credentials to implement standard-based end-to-end encryption), and/or 3) Performance Management (improving key performance metrics such as key recovery time and success rate, encrypted email decryption time, indexing accuracy rate, and other suitable metrics.).

As used herein the term “private encryption key” refers to any credential issued by a cryptography system such as, for example a certification authority, and used to decrypt and/or encrypt data that was previously encrypted and/or decrypted with a corresponding and/or associated public encryption key. The term “asymmetric encryption keys” refers to a pair of keys including an asymmetric encryption key (e.g., a public key) and a corresponding asymmetric decryption key (e.g., a private key). The term “symmetric encryption key” or “symmetric master key” refers to an encryption key that can be used by multiple parties to encrypt and/or decrypt a message and/or dataset.

The term “peer-to-peer private key sharing” or “peer-to-peer private key exchange” is used to describe the methods and devices to securely exchange private keys between, for example, User Sub-Systems in a distributed manner without reliance on a centralized process involving a Certification Authority System (CAS).

Unless specifically stated otherwise, as apparent from the following discussions, it is appreciated that throughout the specification discussions applying terms such as “communicating,” “receiving,” “retrieving,” “sending,” “querying,” “causing,” “determining,” “initiating,” or the like, include action and/or processes of a computer that manipulate and/or transform data into other data, that data represented as physical quantities, e.g. such as electronic quantities, and/or that data representing the physical objects.

The terms “computer”, “processor”, or the like terms should be expansively construed to cover any kind of electronic device with data processing capabilities including, by way of non-limiting example, a digital signal processor (DSP), a microcontroller, a field programmable gate array (FPGA), an application specific integrated circuit (ASIC), or any other electronic computing device having one or more processors of any kind, or any combination thereof.

The operations in accordance with the disclosure herein may be performed by a computer specially constructed for the desired purposes or by a general purpose computer specially configured for the desired purpose by a computer program stored in a non-transitory computer readable storage medium.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

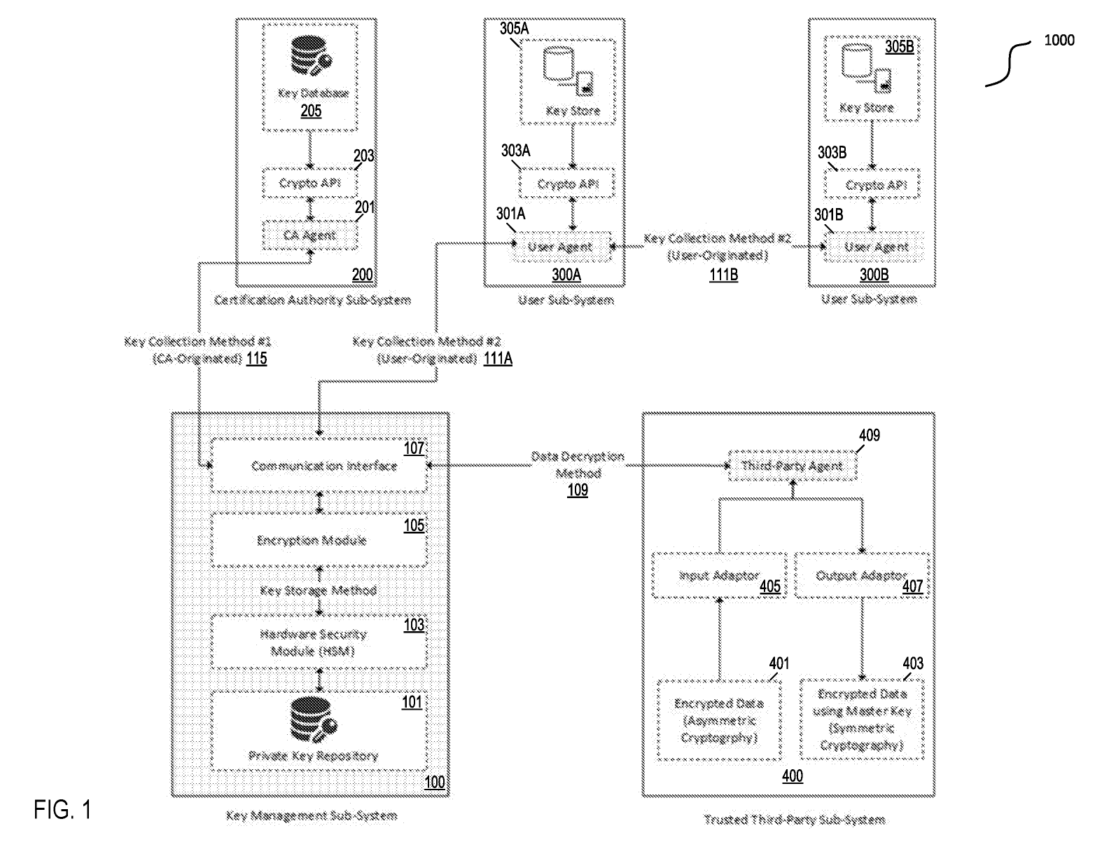

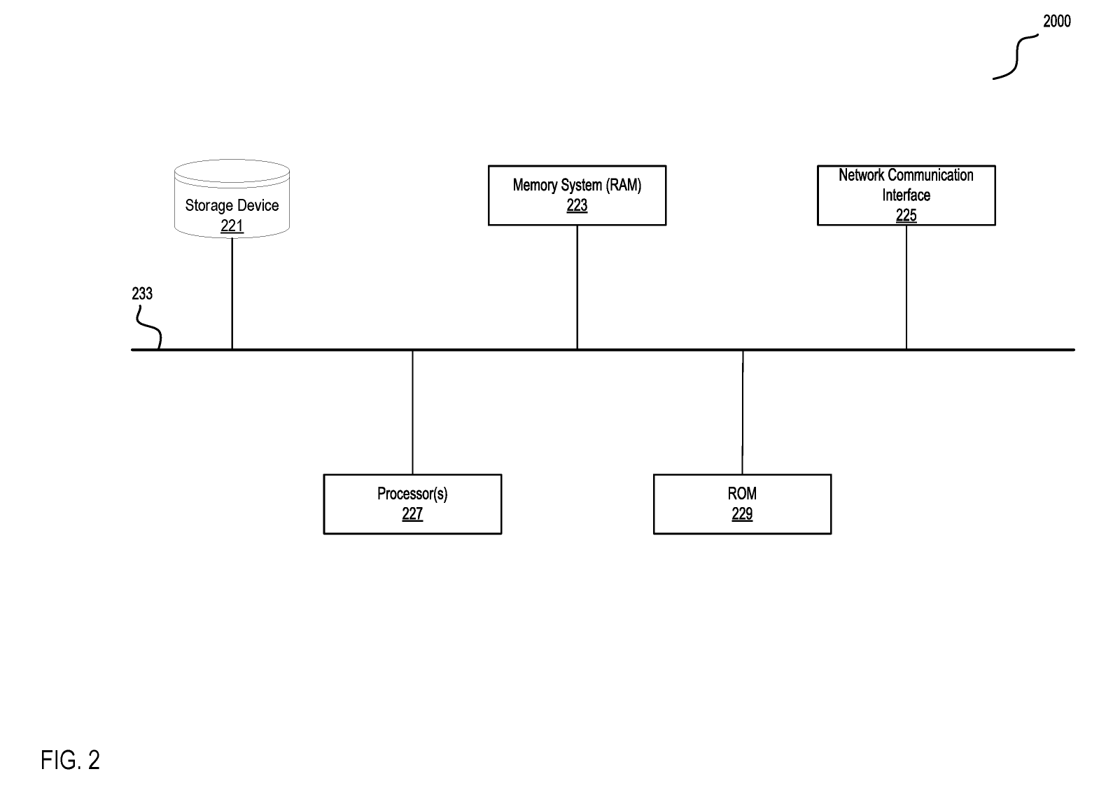

Turning to FIG. 1, FIG. 1 shows a schematic block diagram of a distributed key management system, according to an embodiment. Each one of the sub-systems illustrated in FIG. 1 including sub-systems 100, 200, 300A, 300B and 400 represents a compute device configured with one or more computer processors and a computer memory (including transitory computer memory and/or non-transitory computer memory), which are configured to perform various data processing operations. Examples of such compute devices can include the compute device discussed below with respect to FIG. 2, a personal computer, a portable computer, or any other type of suitable compute device. In some implementations, the shaded elements CA Agent 201, User Agents 301A and 301B, and Third-Party Agent 409 can be implemented as a distributed computing system where the agents are tightly coupled i.e., the agents can exhibit a high degree of interdependence, performing operations in parallel on behalf of a centralized controlling sub-system, for example, the Key Management Sub-System 100, while in other implementations these shaded elements can represent Intelligent Agents that are loosely coupled i.e., the agents can exhibit a low degree of interdependence with a distributed control, in such a case, the agents independently cooperate with one another to perform one or more interdependent processes and the functions described in the presently disclosed subject matter.

As use herein, agents such as the CA Agent 201, the User Agents 300A-300B and the Third-Party Agent 409, can be autonomous systems that receive information from their environment (e.g., from other sub-systems connected to the network 1000 and not shown in FIG. 1), process that information, and perform actions on their environment. Agents can have different degrees of processing logic and can be implemented in a combination of hardware and/or software. In the presently disclosed subject matter, one or more of the agents can be implemented as an extension of the Key Management Sub-System 100.

The network 1000 shown in FIG. 1 is a general example. Network 1000 can include one or more types of communication networks between the sub-systems 100, 200, 300A, 300B and 400. For example, communication networks can include any one of: the Internet, local area network (LAN), wide area network (WAN), metropolitan area network (MAN), various types of telephone networks (including for example PSTN with DSL technology) or mobile networks (including for example GSM, GPRS, CDMA etc.), or any combination thereof. Communication within the network 1000 can be performed through any suitable connection (including wired and/or wireless) and communication technology or standard (WiFi®, 3G®, LTE™, or other suitable standard).

In the general example, the communication network 1000 includes 1) a Key Management Sub-System 100, 2) a Certification Authority Sub-System 200, 3) a set of User Sub-Systems 300A-300B, and 4) a Trusted Third-Party Sub-System 400. Each sub-system's structure and functionality is described below.

The Key Management Sub-System 100 includes a Communication Interface 107, an Encryption Module 105, a Hardware Security Module (HSM) 103 and a Private Key Repository 101. In some implementations, the Communication Interface 107 can use connection protocols such as, for example, direct connect, Ethernet (thick, thin, twisted pair 10/100/1000 Base T, and/or the like), token ring, wireless connection and other suitable types of network connection protocols.

In some implementations, the Key Management Sub-System 100 can include multiple Communication Interfaces 107, where each of the multiple Communication Interfaces 107 can be configured to exchange data across a different communications network type. For example, multiple Communication Interfaces 107 can be used to allow for the communication over broadcast, multicast, and/or unicast networks. In some implementations, the Communication Interface 107 can be implemented using the network communication interface 225 discuss below with respect to FIG. 2.

In some implementations, the Communication Interface 107 can include a network-based application hosted physically or virtually (e.g., using a Hypervisor) on a dedicated operating system of the Key Management Sub-System 100, and can communicate with, for example, the CA Agent 201, User Agents 301A-301B and Third-Party Agent 409. In some implementations, the network-based application can be a web application, thus the agents 201, 301A-301B, and 409 can receive one or more services from the Key Management Sub-System 100 by sending Secure Hypertext Transfer Protocol (HTTPS) requests over the Internet (not shown in FIG. 1) to the Communication Interface 107. In other implementations, the network-based application can be an intranet application configured to operate on a private network. Other further implementations can include network applications operating at other suitable network layers of the Open System Interconnection (OSI) model, for example utility programs managing computer resources of a sub-system, programs managing and terminating connections between applications and other suitable applications can, for example, operate at the session, transport, network data link and physical layers.

In some instances, the Key Management Sub-System 100 can communicate via the Communication Interface 107 with the CA Agent 201, User Agents 301A-301B and Third-Party Agent 409 using encrypted SSL connections through certificate-based mutual authentication. In some other instances, the Key Management Sub-System 100 can communicate with the agents using other suitable protocols that can provide data encryption and authentication between applications and servers in scenarios where that data is being sent across an insecure network, for example, Transport Layer Security (TLS) protocol. Other suitable secure communication protocols can include, for example, 1) Secure/Multipurpose Internet Mail Extensions (S/MIME) for secure messaging between users, and other non-person entities (NPEs); 2) Key Management Interoperability Protocol (KMIP) for cloud security; 3) Mobile Device Management (MDM) for mobile device security; 4) Internet Protocol Security (IPSec) for Virtual Private Network (VPN) security; 5) Wireless Local Area Network (WLAN) for wireless network security and/or the like secure communication protocols.

In some instances, the Encryption Module 105 can be a distributed application performing a portion of the sub-system 100 functionality and logic, and can be hosted physically or virtually via a separate dedicated operating system. In some other instances, the Encryption Module 105 can be implemented as a centralized application as part of a single compute device (e.g., the compute device of FIG. 2).

In some implementations, the Encryption Module 105 can facilitate the encryption and/or decryption of data. The Encryption Module 105 can process symmetric and asymmetric (e.g., Pretty Good Protection (PGP)) encryption and/or decryption. In some implementations, the Encryption Module 105 can employ cryptographic techniques such as, for example, digital certificates (e.g., X.509 authentication framework), digital signatures, dual signatures, enveloping, password access protection, public key management, and other suitable type of cryptographic techniques. The Encryption Module 105 can facilitate numerous (encryption and/or decryption) security protocols such as, for example, checksum, Data Encryption Standard (DES), Elliptical Curve Encryption (ECC), International Data Encryption Algorithm (IDEA), Message Digest 5 (MD5, which is a one way hash operation), passwords, Rivest Cipher (RCS), Rijndael (AES), RSA, Secure Hash Algorithm (SHA), Secure Socket Layer (SSL), Secure Hypertext Transfer Protocol (HTTPS), and/or other suitable security protocols.

In some implementations, the HSM 103 can, for example, be a FIPS 140 Level 3-Compliant cryptographic module through either a hardware implementation or a software implementation (stored in memory or executed on a processor) that supports PKCS #11 as an interface. In some implementations, the HSM 103 module can be configured as part of general purpose processor(s) (e.g., processor(s) 227 in FIG. 2) within the Key Management Sub-System 100. In some further implementations, the HSM 103 can be implemented with specialized cryptographic processors, for example, Broadcom's CryptoNetX™; SecureCore Processors™; nCipher's nShield™; Sun's Cryptographic Accelerators™; and other suitable specialized processors.

In some implementations, the Private Key Repository 101 can be any suitable database including, for example, a Relational Database Management System (RDBMS). In some instances, the Private Key Repository 101 can be implemented via various RDBMSs such as MySQL™, Oracle™, SQL Server™, DB2™ or other suitable RDBMS. Optionally, the Private Key Repository 101 can be implemented via various Database Management Systems (DMS) storing data as files such as dBase™, Microsoft Access™, FoxPro™ or other suitable DMS. Other further options to implement the database in the Private Key Repository 101 can include an Object Oriented Database Management System (OODBMS), an Object Relation Database Management System (ORDBMS), Hierarchical DBMS, Network DBMS, and/or other suitable type of database management system.

In some alternative or additional implementations, the Private Key Repository 101 can be implemented using multiple standard data-structures, such as an array, hash, (linked) list, structured text file (e.g., XML), table, and/or other suitable data structures. Such data structures can be stored in memory (e.g., in the storage device 221 in FIG. 2). In other alternative or additional implementations, an object-oriented database may be used to store key Blobs (KBLOBs) and/or other suitable objects maintained by the Key Management Sub-System 100. For example, a simple key BLOB, known as a SIMPLEBLOB, is a session key that has been encoded with the public key exchange key of the destination user. Public key exchange keys are used to encode session keys so they can be stored with an additional layer of safety and exchanged with other users. This type of key BLOB is often used when storing a session key or transmitting a session key to another user. Other types of key BLOBS can be similarly stored in an object-oriented database including, for example, PUBLICKEYBLOBs containing the public key portion of a public/private key pair, PRIVATEKEYBLOBs containing one complete public/private key pair, and other suitable types of key BLOBs can be maintained by the Management Sub-System 100.

In some instances, when the Key Management Sub-System 100 is implemented using a compute device such as the compute device described in FIG. 2, the object databases can be stored in, for example, the storage device 221 in FIG. 2 and can include a number of object collections grouped and/or linked together by common attributes. Object-oriented databases perform similar to relational databases with the exception that objects are not just pieces of data but may have other types of capabilities encapsulated within a given object. Also, the database may be implemented as a mix of data structures, objects, and relational structures. Databases can be consolidated and/or distributed in multiple variations through standard data processing techniques. Portions of databases, e.g., tables, may be exported and/or imported and thus decentralized and/or integrated.

In some instances, the Private Key Repository 101 within the Key Management Sub-System 100 and the Key Database 205 within the CA Sub-System 200 can share common functionality and/or architectural characteristics and in some instances can be substantially an exact replicate of each other. In some other instances, the Key Database 205 can contain a complete set of user keys whereas the Private Key Repository 101 can contain a subset of user keys within the Private Key Repository 101.

While described above as each using a dedicated operating system, in other embodiments, the Communication Interface 107, the Encryption Module 105, the HSM 103 and/or the Private Key Repository 101 can be implemented within an operating system shared between the components on the Key Management Sub-System 100.

The Certification Authority Sub-System 200 includes a Key Database 205, a Crypto Application Programing Interface (API) 203, and a Certification Authority (CA) Agent 201. The Key Database 205 can be any suitable database discussed above with respect to the Private Key Repository 101. The Key Database 205 can be part of a Certification Authority Service (CAS) and can store copies of private encryption (aka encipherment) keys with the original key being securely delivered to the user.

The Crypto API 203 can be an API implemented as a hardware and/or software module (e.g., in one or more of the memories described with respect to FIG. 2) and/or executed by a processor of the Certification Authority Sub-System 200. The Crypto API 203 can contain a software library of key management functions and can provide an interface between the CA Agent 201 and the Key Database 205. In some instances, the Crypto API 203 can provide support for any suitable public key management standard such as, for example, public-key cryptography standards (PKCS) #11. The CA agent 201 can make key retrieval calls through the Crypto API 203 to collect user private encryption keys individually or in bulk.

The CA Agent 201 can be implemented as a hardware and/or software module (e.g., in a memory) and/or executed by a processor of the Certification Authority Sub-System 200. The CA Agent 201 can make API calls through the Crypto API 203 to, for example, query data stored in the Key Database 205, add, update and delete data in the Key Database 205, obtain metadata about the data stored in the Key Database 205, run utilities to perform administration tasks over the Key Database 205, and other suitable operations. Accordingly, in some implementations, the Crypto API 203 can retrieve user encryption keys from the Key Database 205 and forward collected keys to the Communication Interface 107 in the Key Management Sub-System 100. In some instances, the CA Agent 201 can receive private encryption key requests from the Communication Interface 107, execute one or more API calls provided by the Crypto API 203 and retrieve the requested private encryption keys from the Key Database 205. Thereafter, the CA Agent 201 can send the requested key(s) to the Communication Interface 107. In other instances, the CA Agent 201 can periodically execute a call to the Crypto API 203 to retrieve one or more private encryption keys from the Key Database 205 that have not been sent to the Key Management Sub-System 100. For example, the CA Agent 201 can periodically send new or updated digital certificates, private keys and/or asymmetric keys that have been issued and signed by the Certification Authority Sub-System 200, before these digital certificates and/or keys are requested by the Key Management Sub-System 100. Accordingly, in some instances, the Key Management Sub-System 100 can collect certificates, keys or other security related data directly from a Certification Authority Sub-System 200 as part of a first key collection technique 115.

The User Sub-System 300A includes a User Agent 301A, a Crypto API module 303A, and a Key Store database 305A. In some implementations, the User Agent 301A can execute one or more API calls defined and implemented by the Crypto API 303A. For example, the User Agent 301A can execute an API call to retrieve one or more encrypted private keys, asymmetric keys, symmetric keys and/or digital signatures stored in the Key Store database 305A. In other words, the User Agent 301A can access the Key Store database 305A via the Crypto API 303A. Such an API call can include, for example, a procedure call to retrieve a KBLOB from the Key Store database 305A. The API call can similarly include, procedure calls to retrieve a private key, a public key, a user or subject unique identifier, a User Sub-System unique identifier, a session key, a digital signature, and other suitable authentication and encryption values. In some implementations, the Key Store database 305A can be implemented in a memory or repository (e.g., in the storage device 221 in FIG. 2). The Key Store database 305A can be, for example, a relational database management system or any other suitable type of structured repository with indexed information implemented in the memory of the Key Store module 305. The Key Store database 303A can be implemented as described with respect to the Private Key Repository 101 thus, having similar functionality and/or architectural characteristics.

The User Sub-System 300B can include a User Agent 301B, a Crypto API module 303B, and a Key Store database 305B which can be in some aspects structurally and/or functionally similar to the User Agent 301A, the Crypto API 303A and the Key Store database 305A of the User Sub-System 300A.

In some instances, the Key Management Sub-System 100 can collect private encryption keys from a User Sub-System (e.g., 300A and 300B) as part of a second key collection technique shown at 111A. In such an instance, for example, the User Sub-System 300A can store private encryption keys associated with one or more applications associated or hosted by the User Sub-System 300A. For another example, the User Sub-System 300A can also include private encryption keys associated with or hosted by a different User Sub-System. For instance, the User Sub-System 300A can store private encryption keys associated with one or more applications associated with or hosted by the User Sub-System 300B. In such a case, the User Sub-System 300A can perform a peer-to-peer key exchange with the User Sub-System 300B as part of the second key collection technique shown at 111B.

FIG. 2 is a schematic block diagram illustrating some of the components included in a sub-system of a distributed key management system according to an embodiment. In some implementations, one or more of the Key Management Sub-System 100, the Certification Authority Sub-System 200, the User Sub-Systems 300A and 300B, and the Trusted Third-Party Sub-System 400 can be implemented using the arrangement of the compute device 2000 shown in FIG. 2. The compute device 2000 can be implemented in a personal computer, a server, or any other sort of suitable electronic device. Compute device 2000 can include a bus 231, one or more processor 227, a memory system (RAM) 223, a read only memory (ROM) 229, a disk storage device or repository 221, and a network interface 225. In some implementations, a sub-system can include more than one of the components 221, 223, 225, 227, 229, 231 and other suitable components.

The bus 231 collectively represents all system, peripheral, and chipset buses that communicatively connect the numerous internal devices of the compute device 2000. For instance, the bus 231 can communicatively connect the processor 227 with the ROM 229, the memory system RAM 223, and the storage device or repository 221.

In some implementations, the processor 227 can retrieve from the memories 221, 223 and 229 instructions to execute and data to process in order to execute the processes in the presently disclosed subject matter. The processor 227 can be, for example, a single processor or a multi-core processor in different implementations.

The read-only-memory (ROM) 229 can store static data and instructions that can be used by the processor 227 and other modules of the compute device. The storage device or repository 221 can be a read-and-write memory device. The storage device or repository 221 can be a non-volatile memory unit storing instructions and data even when the compute device 2000 is off. Some implementations of the presently disclosed subject matter can use a mass-storage device (for example a magnetic or optical disk and its corresponding disk drive) as the disk storage or repository 221.

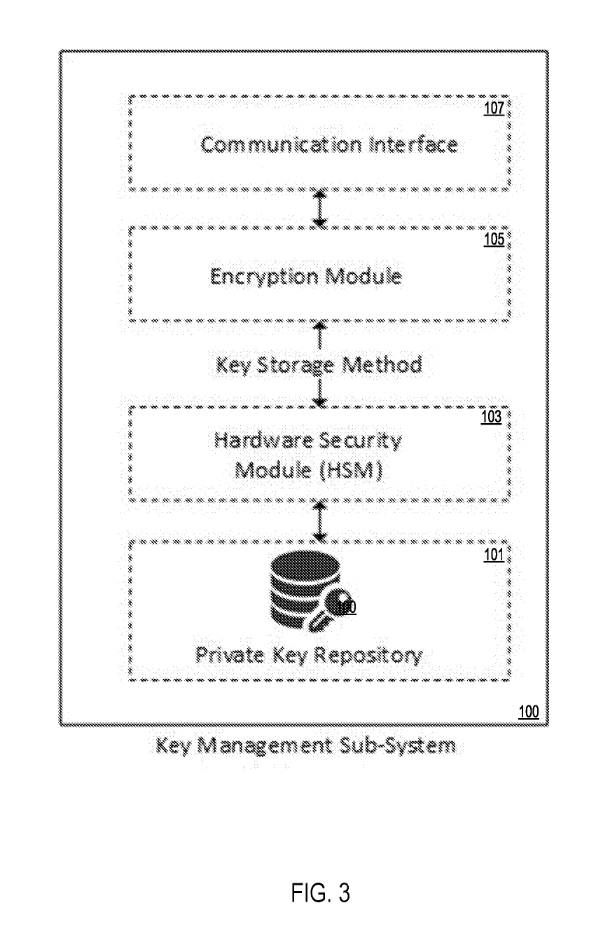

In some implementations the compute device 2000 can use a removable storage device (for example flash drive and its corresponding disk drive) as the storage device or repository 221. Like the storage device 221, the memory system 223 can be a read-and-write memory device. Optionally, the memory system 223 can be a volatile read-and-write memory, such a random access memory (RAM). The memory system 223 can store some of the instructions and data that the processor 227 used at runtime. In some implementations, the processes of the subject technology can be stored in the memory system 223, the storage device or repository 221, or the ROM memory 229. For example, the various memory units can include instructions for providing the functions described with respect to FIGS. 3 to 9 in accordance with some implementations. From these various memory units, the processor 227 can retrieve instructions to execute and data to process in order to execute the processes of some implementations.

The bus 231 can couple the compute device 2000 to a network (not shown in FIG. 2) through a network communication interface 231. In this manner, the compute device 2000 can be a part of a network of computers (for example a local area network (“LAN”), a wide area network (“WAN”), or an Intranet, or a network of networks, for example the Internet. Any or all components of the compute device 2000 can be used by the sub-systems 100, 200, 300A, 300B and 400 shown in FIG. 1 in conjunction with the disclosed subject matter.

In some implementations, one or more functional features described throughout the presently disclosed subject matter can be implemented as software processes that are specified as a set of instructions recorded on a computer readable storage medium (e.g., memories 221, 223, 229 or other suitable memory). When these instructions are executed by one or more processor 227 (e.g., one or more processors, cores of processors, or other processing units), they cause the processor to perform the actions indicated in the instructions. Examples of computer readable media include, but are not limited to, CD-ROMs, flash drives, RAM chips, hard drives, EPROMs, and other suitable memories. The computer readable media does not include non-transitory carrier waves and electronic signals transmitted wirelessly or over wired connections.

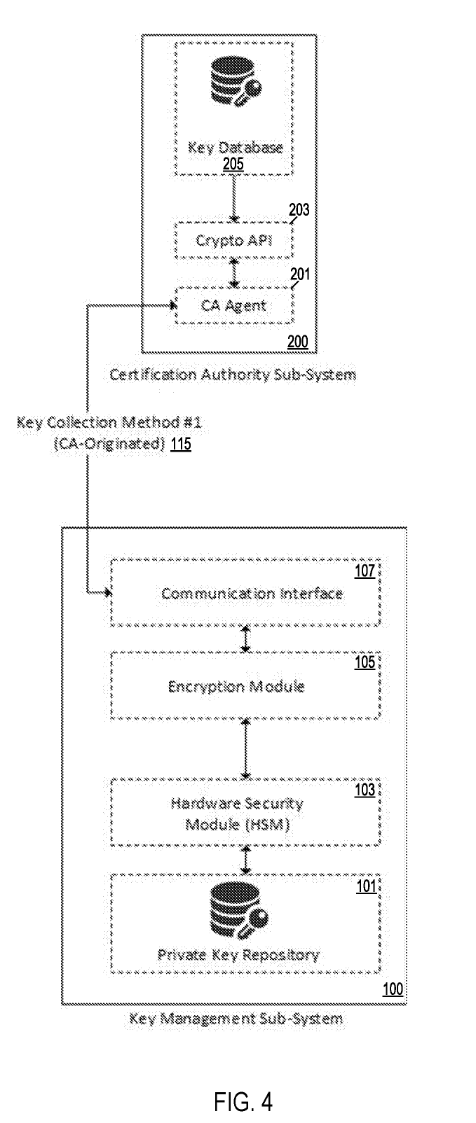

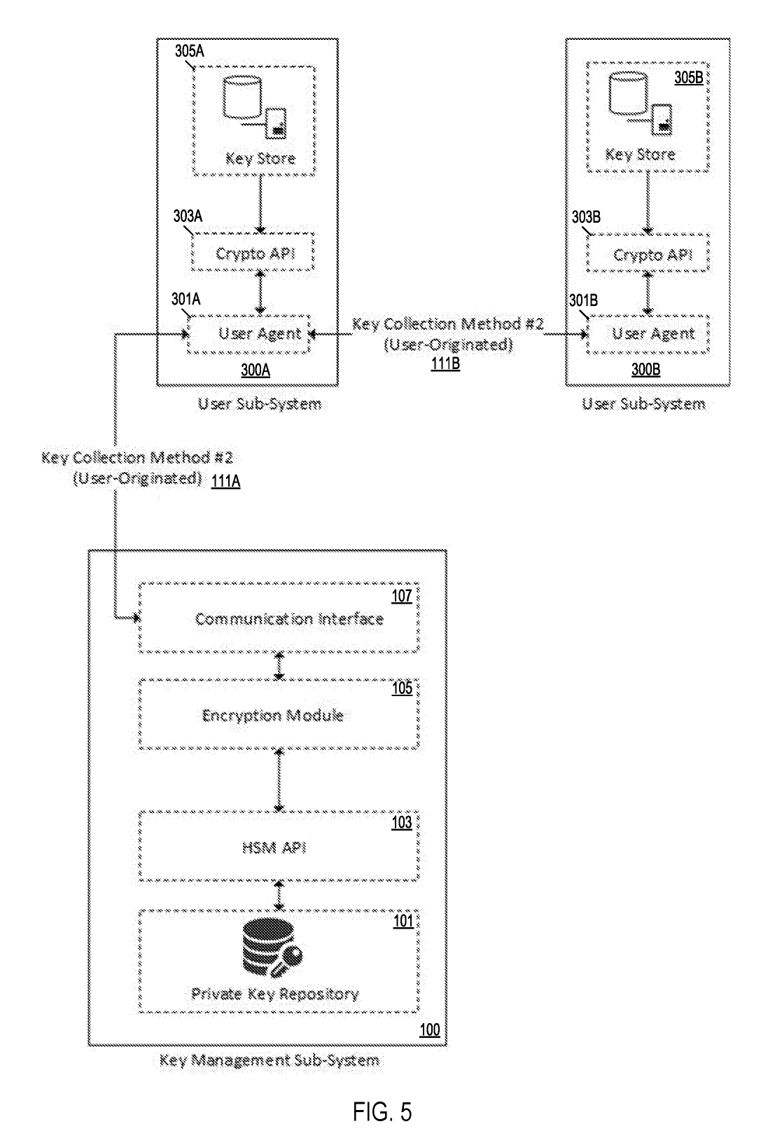

FIG. 3 is a schematic block diagram of a key management sub-system shown in FIG. 1, according to an embodiment. The components and/or modules of the key management sub-system 100 can allow the Trusted Third-Party Sub-System 400 shown in FIG. 1 to receive a decryption of the content of encrypted messages or datasets without direct access to associated, digital signatures, private encryption keys, and/or asymmetric decryption keys. Specifically, the Key Management Sub-System 100 can receive, retrieve and/or store copies of the decryption keys from the Certification Authority Sub-System 200 (e.g., FIG. 4) and/or the User Sub-Systems 300A-300B (e.g., FIG. 5) as described below.

In some implementations, the Communication Interface 107 can accept, communicate, and/or connect to a communications network. The Key Management Sub-System 100, via the Communication Interface 107 can receive private encryption keys, asymmetrical keys, symmetrical keys, digital signatures and/or other suitable authentication and/or encryption data from the Certification Authority Sub-System 200, User Sub-Systems 300A-300B, the Trusted Third-Party Sub-System 400 and/or other suitable compute devices.

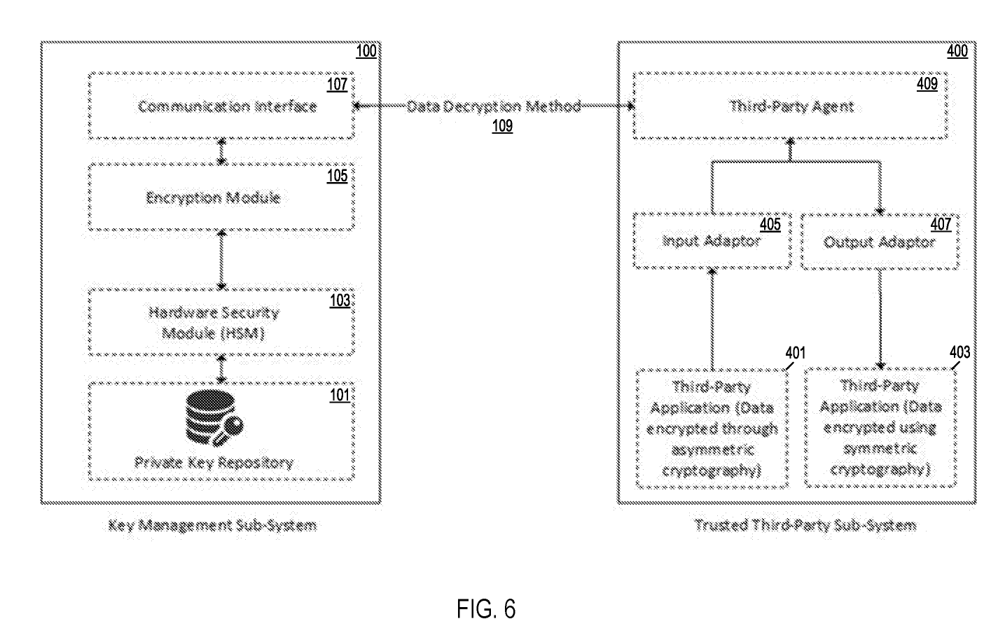

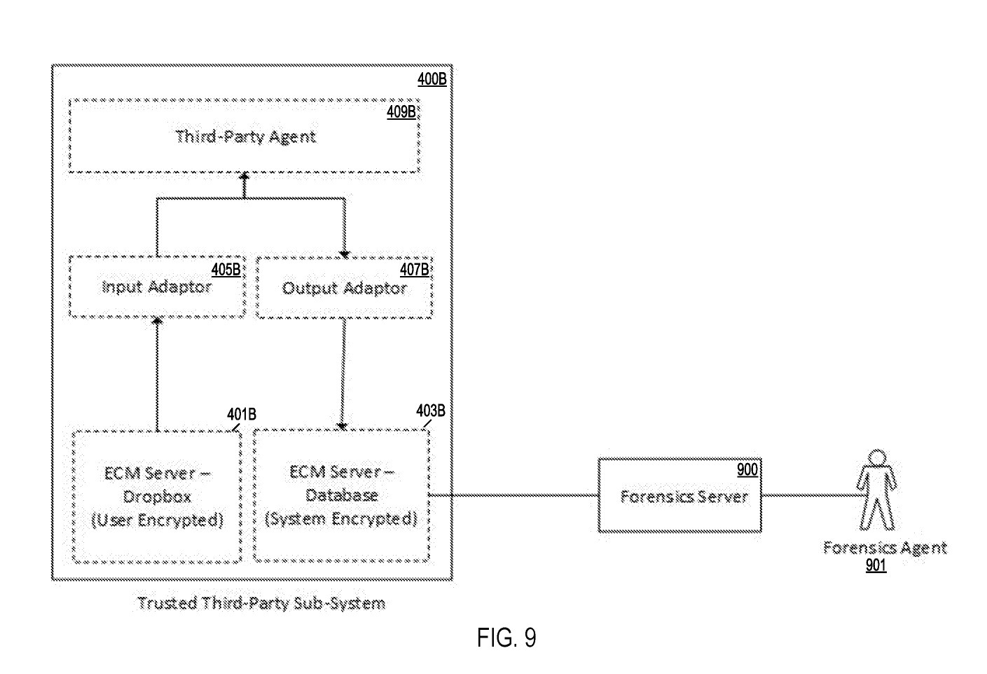

In some implementations, the Encryption Module 105 can decrypt data with one or more private encryption keys, asymmetric decryption keys, symmetric keys, and/or digital signatures collected through the key collection 115, 111A-111B (shown in FIG. 1) and/or by retrieving a corresponding key from the cache memory of the HSM 103 or the Private Key Repository 101. Thereafter, the Encryption Module 105 can re-encrypt the decrypted data with a symmetric master key, forward the re-encrypted data to the Communication Interface 107 such that, the Key Management Sub-System can send the re-encrypted data to the Third-Party Agent 400 shown in FIG. 1. The decryption and re-encryption process is described in more detail below with respect to FIG. 6 and FIG. 9.

Using Secure/Multipurpose Internet Mail Extensions (S/MIME) as an example, in some instances, one of the functions of the Encryption Module 105 is to decrypt the received Message Encrypted Session Key (MESK) and return the corresponding unencrypted Message Session Key (MSK) to the Third-Party Agent 409 within the Trusted Third-Party Sub-System 400. This message encryption can ensure that an encrypted message is unreadable until a private encryption key is presented. The private encryption key or asymmetric encryption key can be used to securely transmit an encrypted message key (i.e., a MESK). Because a MESK can be securely transmitted to a recipient, a symmetric MSK can be used to encrypt the message and then encrypt the symmetric MSK using, for example, an asymmetric encryption key. Accordingly, only the holder(s) of a corresponding asymmetric decryption key can unlock the symmetric MSK, which then can be used to decrypt the message. This operation functions as if the entire message had been encrypted and decrypted using the asymmetric encryption and decryption keys. Because this operation, however, uses a faster, symmetric MSK on most of the information (i.e., the body of the message) the operation is faster than it would be otherwise.

The Encryption Module 105 can handle decryption requests received by the Communication Interface 107 from the Third-Party Agent 409 involving one or more private encryption keys and/or asymmetric decryption keys. For example, Encryption Module 105 can determine that a decryption request involves one or more keys and thus can perform one or more key request operations.

In some instances, the Encryption Module 105 can request and retrieve one or more keys stored within the Key Management Sub-System 100 during the processing of previous decryption requests. In some instances, keys can be cached during previous decryption requests in the HSM 103. In other instances keys can be stored in the Private Key Repository 101 (e.g., in a database or file). In some other instances, if the keys are no longer stored in the HSM 103 (for example, the keys were cleared from the HSM cached memory or have never been processed by the HSM 103), the KBLOB data can be loaded from the Private Key Repository 101 and reloaded into HSM 103 to service the decryption request.

After private encrypted key(s) or asymmetric decryption key(s) also referred hereinafter as user keys are located and loaded, they can be used to perform decryption process of the MESK and retrieve the MSK for message decryption. Accordingly, in some implementations, the communication associated with key requests and key responses between the Key Management Sub-System 100 and Trusted Third-Party Sub-System 400 can be handled by the Communication Interface 107 and the Third-Party Agent 409 as part of the data decryption technique 109.

FIG. 4 is a schematic block diagram of a portion of a key management system shown in FIG. 1 illustrating key collection from a key database residing in a Certification Authority (CA) Sub-System, according to an embodiment. The Certification Authority Sub-System 200 and the Key Management Sub-System 100 can conduct the collection 115 of the private encryption keys. For example, when a Certification Authority Sub-System 200 issues credentials for a person entity and/or an NPE, an instance of a private encryption key, an asymmetric key, a symmetric key, and/or a digital signature can be copied to the Key Database 205 of the Certification Authority Sub-System 200 and a corresponding key can be sent to a user key store (e.g., shown in FIG. 1 as the Key Store 305A on the User Sub-System 300A). An encryption key or pair of keys (private and public) can be associated with the person for whom the credentials are being issued. FIG. 4 shows how, for example, private encryption keys, and/or asymmetric key pairs stored in the Certification Authority Sub-System 200 can be copied and pulled into the Key Management Sub-System 100 to execute, for example, one or more decryption processes. This process is transparent to the user and non-intrusive to the user authentication process.

Continuing with the case of S/MIME content, the Encryption Module 105 can extract from a message header a set of user certificate identifiers including issuer name, validity period, subject name, subject public key information, issuer unique identifier, subject unique identifier, certification authority's digital signature, and their corresponding message encrypted session keys (MESK) and send such information to the HSM 103 for MESK decryption. In some embodiments, if the HSM 103 has at least one corresponding protected private encryption key, the HSM 103 uses this key to decrypt the MESK and return the MSK to the Encryption Module 105, which uses the key to decrypt the message, re-encrypt the message with a symmetric master key, and send the symmetrically encrypted message to the output adaptor 407A via the Third Party Agent 409 of the Trusted Third-Party Sub-System 400A (shown in FIG. 1). In some cases, when the Encryption Module 105 is unable to identify a corresponding private key in the HSM 103 cache, the Encryption Module 105 uses the Communication Interface 107 to securely retrieve at least one corresponding private encryption key and/or asymmetric key(s) (e.g., from the Certification Authority Sub-System or from a User Sub-System shown in FIG. 1).

FIG. 5 is a schematic block diagram of a portion of a key management system shown in FIG. 1 illustrating key collection from key stores residing in multiple User Sub-Systems, according to an embodiment. In some instances, the User Agent 301A on a User Sub-System 300A can run as a script each time a user logs into the operating system of that User Sub-System 300A and if a criterion is met (e.g., a new key has been issued since the last login); the User Agent 301A can forward a copy of the user(s) private encryption key(s) or asymmetric encryption key(s) to the Communication Interface 107 within the Key Management Sub-System 100.

In some other instances, the Key Management Sub-System 100 can send to the User Agent 301A a request for one or more copies of user keys (e.g., private encryption keys or asymmetric encryption keys). Thus, the Key Management Sub-System 100 can retrieve user keys upon request from User Sub-Systems 300A and/or 300B, for example, whenever connectivity is lost between the Key Management Sub-System 100 and the Certification Authority Sub-System 200. In yet some other instances, the User Agent 301A can retrieve one or more user keys from the Key Store 305A via the Crypto API 303A at a predetermined interval of time and thereafter push a batch of user keys to the Key Management Sub-System 100.

In addition to sharing keys with the Communication Interface 107, the User Agents 301A and 301B can share or exchange keys with each other through a peer-to-peer key exchange or sharing configuration 111B. In some instances, a User Agent can store a peer list identifying other User Agents. The User Agents included in such a peer list can be selected based on multiple criteria including geographical proximity between User Sub-Systems, relationship between the users of two different User Sub-Systems (for example, the users of User Sub-System 300A and 300B work for the same company), the usage frequency of a User Sub-System or other suitable criteria. The evaluation of the criteria and/or selection of Users Sub-Systems to be included in a User Agent peer list can be made in some instances by the Key Management Sub-System 100 and in some other instances by a User Agent.

In some instances, a User Agent showing a “high” usage frequency has a greater probability to have stored in its local Key Store the most recently issued encryption keys for a given user than User Agents in User Sub-Systems showing a “low” usage frequency. In some implementations, a first User Agent (e.g., User Agent 301B) can calculate the usage frequency by, for example, tracking the number of logins users make over time to a first User Sub-System (e.g., User Sub-System 300B). The first User Agent can send the calculated usage frequency to a second User Agent (e.g., User Agent 301A) and/or to the Key Management Sub-System 100. The second User Agent and/or the Key Management Sub-System 100 can evaluate the usage frequency value sent by the first User Agent and based on the evaluation decide whether or not to update the second User Agent's peer list. For example, if the first User Agent can show a “high” usage frequency (e.g., above a predetermined threshold), then the second User Agent can update its peer list to include an identifier corresponding to the first User Agent. Such an identifier can be sent in some instances by the first User Agent and in other instances by the Key Management Sub-System 100. Accordingly, the second User Agent can request keys from the first User Agent for example, in response to a command request sent by the Key Management Sub-System 100.

In some implementations, the User Agent 301A can request a peer-to-peer key exchange to the User Agent 301B at predetermined intervals of time, and/or whenever is requested by the Key Management Sub-System 100. For example, the Key-Management Sub-System 100 can request one or more user keys to the User Agent 301A. The User Agent 301A can verify whether or not the requested user keys are stored in the local key Store 305A. In some instances one or more of the requested user keys may not be available at the Key Store 305A. In such a case, the User Agent 301A can send a request to one or more User Agents included in its peer list, for example the User Agent 301B.

In some instances, each User Agent 301A-301B can forward selected keys to the Communication Interface 107 within the Key Management Sub-System 100. As such, the Key Management Sub-System 100 can receive user encryption keys from User Sub-Systems 300A-300B based on the peer-to-peer communications 111B between those User Sub-Systems. This is an additional or alternative to the key collection technique 115 in which an encryption key is retrieved from the CA Key Database 205 as illustrated in FIG. 4 and presents benefits from both performance and business continuity perspectives. For example, in bandwidth-constrained user environments, it may make sense to assign some User Agents as key collection hubs. For another example, a loss of connectivity with the CA Sub-System 200 can be another reason for relying on collection of keys via the peer-to-peer communication method. For yet another example, the peer-to-peer communication method can be used between two Certification Authority Sub-Systems having a cross trust relationship.

FIG. 6 is a schematic block diagram of a portion of the key management system of FIG. 1 performing a decryption technique 109. FIG. 6 shows two sub-systems: 1) Key Management Sub-System 100, which can be used to decrypt data previously encrypted using public key technology and to re-encrypt the data using symmetric technology, and a 2) Trusted Third-Party Sub-System 400, which can be used to retrieve encrypted data from trusted third-party applications (e.g. Mail Server or Enterprise Content Management Server) and provide processed re-encrypted data to those trusted third-party applications. In some implementations, the Trusted Third-Party Sub-System 400 can be implemented on the compute device discussed above with respect to FIG. 2.

The Trusted Third-Party Sub-System 400 can be, for example, an organization's email server having an input adaptor 405 configured to pull asymmetrically encrypted messages from a Third-Party Application 401. The Input Adaptor 405 can use, for example, a Web Service (WS) or a Remote Procedure Call (RPC) protocol to pull data 401 encrypted through asymmetric cryptography from the Third-Party Application 401.

In the example of an email server, the input adaptor of the Trusted Third-Party Sub-System 400 can use a local database implemented in, for example, the Storage Device 221 shown in FIG. 2 to store email messages and metadata related to one or more received email messages. In some implementations, the metadata can include a “Timestamp” and a “Message status.” The “Timestamp” can indicate, for example, when was a dataset, or in this case, when was a batch of emails received by the Trusted-Third Party Sub-System 400. The “Message status” can store Boolean logic value (e.g., “TRUE” or “FALSE”) indicating whether or not a particular data (or email message) has been successfully processed by the Third-Party Agent 409. Specifically, the “Message status” associated with an email message can have a “TRUE” value when a corresponding symmetrically encrypted version of such an email message is available to the Third-Party Sub-System, for example, stored in the Storage Device 221 when the Third-Party Sub-System is implemented using the compute device shown in FIG. 2. Whenever a “Message status” associated with an email message has a “FALSE” value, this value can be used by the Third-Party Agent 409 and/or the Input Adaptor 405 to determine that such an email message is to be send to the Key Management Sub-System 100.

In some instances, the Third-Party Agent 409 can periodically select and send asymmetrically encrypted datasets to the Key Management Sub-System 100. For example, in some implementations, the Third-Party Agent 409 can execute a time scheduled process, a daemon thread or any other suitable scheduled or background processes to pull one or more asymmetrically encrypted email messages from an email server and thereafter push them to the Key Management Sub-System 100. The Key Management Sub-System 100 can transform the asymmetrically encrypted dataset into a corresponding symmetrically re-encrypted dataset and send back to the Third-Party Agent 409 a corresponding response with one or more symmetrically re-encrypted email messages according to this example. The Third-Party Agent 409 can then change the “Message status” value (e.g., from “FALSE” to “TRUE”) of the one or more email messages for which symmetrically re-encrypted versions were received.

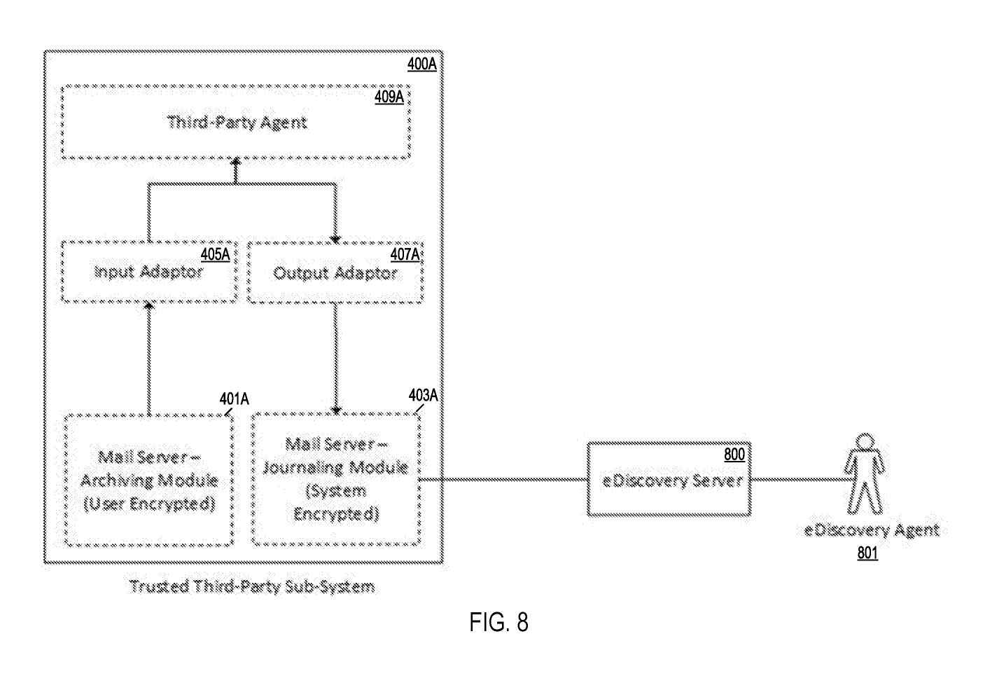

While, in some instances, the “Timestamp” can be used to pull only new datasets and/or messages, the “Message status” can be used to pull datasets that were not successfully re-encrypted in a previous attempt, such that these datasets or messages can eventually be transformed into a corresponding symmetrically re-encrypted dataset. Further aspects of an email server example are discussed below with respect to FIG. 8.

Alternatively or additionally, the Key Management Sub-System 100 can send a request for an asymmetrically encrypted dataset to the Third-Party Agent 409. In such a case, the Key Management Sub-System 100 can control the load of asymmetrically encrypted datasets received by the Third-Party Agent 409.

The output adaptor 407 can be configured to send symmetrically re-encrypted data (e.g., email messages) to a destination service using, for example, Simple Mail Transfer Protocol (SMTP), an insert SQL statement, a local save command or any other type of suitable command or protocol.

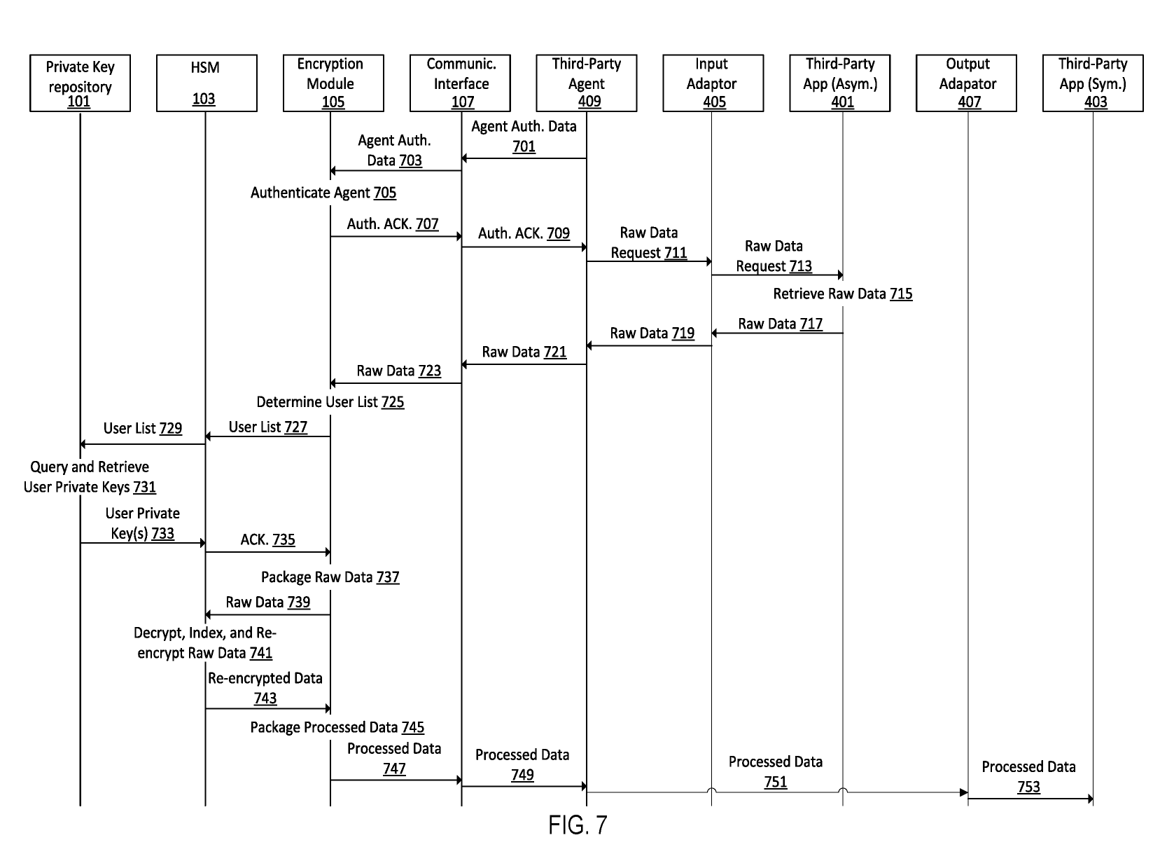

FIG. 7 illustrates a sequence diagram for the decryption method, according to an embodiment. In some implementations, a third-party agent 409 sends, at 701, authentication data to the communication interface 107 of a Key Management Sub-System. The communication interface 107 receives and forwards the authentication data, at 703, to the encryption module 105. The encryption module 105 authenticates, at 705, the third-party agent 409 based on the received authentication data and accordingly sends an authentication acknowledgement message, at 707, to the communication interface 107 to cause the communication interface to forward the authentication acknowledgement to the third-party agent 409, at 709. In some instances the authentication can be performed, for example, through a one-way or a two-way secure socket layer authentication or transport layer security authentication.

In some instances, the authentication acknowledgement can include a failed authentication message, and in such instances, the process can stop. In some other instances, as shown in FIG. 7 the authentication acknowledgement can include a successful authentication message. Thereafter, the third-party agent 409 sends a raw data request, at 711, to the input adaptor 405. The requested data can be, for example, one or more datasets encrypted with an asymmetric key. In some instances, the input adaptor 405 can preprocess the received request, for example, to determine whether or not the request can be accepted and/or is allowed according to predefined system polices or other suitable constraints.

In some implementations, the input adaptor 405 sends a corresponding raw data request, at 713, to the third-party application 401. The third-party application 401 can manage and/or store one or more datasets encrypted with one or more asymmetric encryption keys. The third-party application 401 retrieves the requested raw data, at 715, from a repository (e.g., a database) and thereafter, sends the corresponding raw data, at 717, to the input adaptor 405. The input adaptor 405 forwards the received raw data, at 719, to the third-party agent 409, and the third-party agent 409 further forwards the raw data, at 721, to the communication interface 107.

The communication interface 107 receives raw data encrypted with an asymmetric encryption key and forwards the received raw data to the encryption module 105, at 723. The encryption module 105 determines based on the received raw data one or more users or NPEs associated with the received raw data and accordingly generates, at 725, a list with identifiers associated with and/or identifying the determined users or NPEs (referred to a “user list”). Accordingly, the encryption module 105 sends a list with the identifiers of one or more users or NPEs, at 727, to the HSM module 103. Thereafter, the HSM module sends, at 729, the user list to the private key repository 101 in compliance with one or more security standards.

In some implementations, the private key repository 101 can include an instance of a database with records corresponding to one or more private keys associated with one or more users or NPEs. More specific to FIG. 7, the private key repository 101 receives the user list with identifiers associated with users and/or NPEs and generates, for example, a SQL statement to retrieve one or more private keys for each of the identifiers included in the user list, as shown at 731. The private key repository 101 sends the retrieved private keys to the HSM module 103, at 733. The HSM module 103 sends, at 735, an acknowledgment message to the encryption module 105 upon the reception of the user private keys. Thereafter, the encryption module packages the raw data, at 737, and sends the packaged raw data to the HSM module 103, at 739. In some instances, the packages generated and sent by the encryption module are self-contained collections of entities, for example, encryption keys, users' data, metadata and other suitable type of data and information. In some further instances, a package can also include a specification with an indication of the data the package contains and/or one or more procedures or routines to, for example, unpackage the raw data along with instructions defining operations to process the raw data, for example, to store the raw data in a repository controlled by an application, e.g., the Third-Party App 403.

In some implementations, the HSM module, at 741, decrypts, indexes and re-encrypts received raw data according to one or more security standards. The re-encryption process can be performed using a symmetric encryption key. In some implementations, one or more trusted third-party sub-systems can have a corresponding key for the symmetric encryption key. For example, a trusted third-party sub-system can have a corresponding public key of a symmetric encryption key used, at 741, and thus, the symmetric encryption key, in some instances, is available to the third-party agent 409. The HSM module sends, at 743, the re-encrypted data to the encryption module 105. The encryption module 105 packages the processed data including the re-encrypted version of the data, at 745. Thereafter, the encryption module 105 sends, at 747, the processed data to the communication interface 107. The communication interface 107 sends, at 749, the processed data to the third-party agent 409 so the processed data is stored in the third-party application module 403 according to the sequence depicted at 749, 751 and 753 in FIG. 7.

While various embodiments have been described above, it should be understood that they have been presented by way of example only, and not limitation. Where methods and/or schematics described above indicate certain events and/or flow patterns occurring in certain order, the ordering of certain events and/or flow patterns may be modified. While the embodiments have been particularly shown and described, it will be understood that various changes in form and details may be made. Additionally, certain of the steps may be performed concurrently in a parallel process when possible, as well as performed sequentially as described above. Although various embodiments have been described as having particular features and/or combinations of components, other embodiments are possible having any combination or sub-combination of any features and/or components from any of the embodiments described herein. Furthermore, although various embodiments are described as having a particular entity associated with a particular compute device, in other embodiments different entities can be associated with other and/or different compute devices.

As a first example, FIG. 8 highlights using a distributed enterprise key management system for eDiscovery. In such an example, an eDiscovery agent 801 uses substantially real-time access to user encrypted user email stored on an email server (e.g., a Trusted Third-Party Sub-System 400A). Given that the encrypted emails have been previously 1) retrieved from an archiving module of the email server by the Trusted Third-Party Sub-System 400A, 2) decrypted by the Key Management Sub-System 100 through access to user private encryption keys, 3) re-encrypted using a symmetrical master key, 4) indexed based on content and security classification, and 5) stored on a journaling module 403A of the email server 400A the eDiscovery agent 801 in communication with the eDiscovery Server 800 can run a query on the journaling module and retrieve desired emails in substantially real-time.

In some implementations, the symmetrically re-encrypted email messages can be accessed by an eDiscovery Agent 801 via the eDiscovery Server 800. Electronic discovery or eDiscovery is the electronic aspect of identifying, collecting and producing electronically stored information (ESI) in response to a request for production in an investigation, for example, a lawsuit. In the first example, shown in FIG. 8 the ESI can include, for example, emails, documents, presentations, databases, voicemail, audio and video files, social media, web sites and/or other suitable electronic information that can be handled by an email server or any other suitable server (e.g., document management server).

The output adaptor 407A can be configured to send, in some instances, symmetrically re-encrypted email messages to a device hosting a destination service using S/MIME, Simple Mail Transfer Protocol (SMTP) or any other suitable email protocol when the destination service is hosted in a different device than the device 400A. In other instance when the destination service is hosted by the device 400A then a request to store the symmetrically re-encrypted email messages can be sent, for example to a local repository (not shown in FIG. 8). Thus, the output adaptor 407A can send and/or request to store one or more symmetrically re-encrypted messages to the Mail Server-Journaling Module 403A.

As a second example, FIG. 9 illustrates a Forensics use case in which a Forensics agent has substantially real-time access to encrypted user content stored on an Enterprise Content Management (ECM) server or Trusted Third-Party Sub-System 400B. Given that the encrypted content has been previously 1) retrieved from a cloud storage service provider 401B (e.g., Dropbox™) by the Trusted Third-Party Sub-System 400B, 2) decrypted by the Key Management Sub-System through access to one or more user private encryption keys or asymmetric decryption keys, 3) re-encrypted using a symmetric master key, 4) categorized based on content and security classification, and 5) stored on the database of the ECM server database 403B, the Forensics Agent 901 can run a database query and retrieve from the database 403B symmetrically encrypted content in substantially real-time.

In some implementations, the Trusted Third-Party Sub-System 400B can be, for example, an Enterprise Content Management (ECM) server 400B as illustrated in FIG. 9. The Input Adaptor 405B, the Output Adaptor 407B and the Third-Party Agent 409A can be in some aspects structurally and/or functionally similar to the Input Adaptor 405, the Output Adaptor 407, and the Third-Party Agent 409 described with respect to FIG. 6

The Input Adaptor 405B can be configured to retrieve and/or pull asymmetrically encrypted data stored or managed by the ECM server module 401B. The Output Adaptor 407B can be configured to send or store symmetrically encrypted data into or through the ECM server database 403B.

In some implementations, the symmetrically re-encrypted data can be accessed by a Forensic Agent 901 via the Forensic Server 900. Accordingly, the Forensic Agent 901 can recover information associated with an ECM, for example, data associated with a cloud storage service provider, and other suitable ECM services. Some variations of the example described with respect to FIG. 9 can include Enterprise Resource Planning (ERP) systems, Customer Relationship Management system, Small and Medium-sized Business (SMB) systems and/other suitable type of information systems.

In addition to the e-Discovery use case described in FIG. 8 and Forensics use case described in FIG. 9, many other use cases can be enabled by the subject matter disclosed herein. Another use case is in the field of data analytics where a digital curation application (acting as a trusted third-party application) can exchange encrypted/re-encrypted data with the Key Management Sub-System to support various stages of the digital curation process. This process can be broadly defined as containing the following steps 1) Conceptualize, 2) Create, 3) Access and Use, 4) Appraise and Select, 5) Dispose, 6) Ingest, 7) Preservation Action, 8) Reappraise, 9) Store, 10) Access and Reuse, and 11) Transform.

While the embodiments described above are based on a stateful key management technology, alternative technologies can use a stateless identity-based key management in which certificates are issued and used as needed and expire quickly. Identity-based encryption is an alternative encryption process that can be initiated by a sender using a unique identifier such as the recipient's e-mail address to calculate a public key as opposed to traditional end-to-end encryption in a stateful implementation in which the sender retrieves the recipient's public key from a Lightweight Directory Access Protocol (LDAP) directory. This approach includes the advantage of not requiring an enterprise key escrow and recovery service. Identity-based key management technologies, however, can be difficult to scale and can be subject to security vulnerabilities due to over-reliance on secure socket layer (SSL)-based virtual private network (VPN) technology and other factors.

Although various embodiments have been described as having particular features and/or combinations of components, other embodiments are possible having a combination of any features and/or components from any of embodiments as discussed above.

It is intended that the systems and methods described herein can be performed by software (stored in memory and/or executed on hardware), hardware, or a combination thereof. Hardware modules may include, for example, a general-purpose processor, a field programmable gates array (FPGA), and/or an application specific integrated circuit (ASIC). Software modules (executed on hardware) can be expressed in a variety of software languages (e.g., computer code), including Unix utilities, C, C++, Java™, Ruby, SQL, SAS®, the R programming language/software environment, Visual Basic™, and other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code. Each of the devices described herein can include one or more processors as described above.

Some embodiments described herein relate to devices with a non-transitory computer-readable medium (also can be referred to as a non-transitory processor-readable medium or memory) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

1. An encryption key management apparatus, comprising:
one or more processors; and
a memory operatively coupled to the one or more processors and storing instructions that when executed by the one or more processors cause the one or more processors to:
receive, from an authorized compute device, a raw dataset that is encrypted with at least one asymmetric encryption key;
determine, based on the raw dataset, an identifier of a first entity associated with the raw dataset and an identifier of a second entity associated with the raw dataset;
retrieve, based on the identifier of the first entity, an instance of an asymmetric decryption key associated with the first entity;
retrieve, based on the identifier of the second entity, an instance of an asymmetric decryption key associated with the second entity;
decrypt at least a portion of the raw dataset using the instance of the asymmetric decryption key associated with the first entity and the instance of the decryption encryption key associated with the second entity to generate define a decrypted raw dataset;
reencrypt the decrypted raw dataset using a symmetric master key to generate a symmetrically encrypted raw dataset; and
send the symmetrically encrypted raw dataset to the authorized compute device.

2. The encryption key management apparatus of claim 1, wherein the one or more processors are configured to use a computer security standard to maintain confidentiality and integrity of the raw dataset, the decrypted raw dataset and the symmetrically encrypted raw dataset.

3. The encryption key management apparatus of claim 1, wherein the one or more processors are configured to use a Federal Information Processing Standard (FIPS) to maintain confidentiality and integrity of the raw dataset.

4. The encryption key management apparatus of claim 1, wherein the first entity associated with the raw dataset is a person.

5. The encryption key management apparatus of claim 1, wherein the first entity associated with the raw dataset is a non-person.

6. The encryption key management apparatus of claim 1, wherein the instance of the asymmetric decryption key associated with the first entity is retrieved by the encryption management apparatus from a local private key repository.

7. The encryption key management apparatus of claim 1, wherein the instance of the asymmetric decryption key associated with the first entity is retrieved by the encryption management apparatus from a certification authority compute device.

8. The encryption key management apparatus of claim 1, wherein the instance of the asymmetric decryption key associated with the first entity is associated with a first user compute device and collected by a second user compute device from the second user compute device in a peer-to-peer exchange.

9. The encryption key management apparatus of claim 1, wherein the instance of the asymmetric decryption key associated with the first entity is associated with a first user compute device and collected by a second user compute device from the second user compute device in a peer-to-peer exchange,
the instructions to cause the one or more processors to retrieve the instance of the asymmetric decryption key associated with the first entity include instructions to cause the one or more processors to retrieve the instance of the asymmetric decryption key associated with the first entity from the second user compute device.

10. The encryption key management apparatus of claim 1, wherein the symmetric master key is different from the asymmetric decryption key associated with the first entity and the asymmetric decryption key associated with the second entity.

11. A non-transitory processor-readable medium storing code representing instructions to be executed by a processor, the code comprising code to cause the processor to:
receive, from a first user compute device, an instance of an asymmetric decryption key associated with a second user compute device and collected by the first user compute device from the second user compute device in a peer-to-peer exchange of the instance of the asymmetric decryption key;
receive, from an authorized compute device, a raw dataset encrypted with an asymmetric encryption key associated with the asymmetric decryption key;
analyze the raw dataset to identify at least one entity associated with the raw dataset, the at least one entity associated with the second user computer device;
decrypt the raw dataset using the instance of the asymmetric decryption key to generate a decrypted raw dataset;
reencrypt the raw dataset using a symmetric master key to generate a symmetrically encrypted raw dataset; and
send the symmetrically encrypted raw dataset to the authorized compute device.

12. The non-transitory processor-readable medium of claim 11, wherein the at least one entity associated with the raw dataset is a user of the second user compute device.

13. The non-transitory processor-readable medium of claim 11, wherein the at least one entity associated with the raw dataset is a user of the second user compute device, the peer-to-peer exchange is performed upon a login request to the second user compute device from the user of the second compute device.

14. The non-transitory processor-readable medium of claim 11, wherein the symmetric master key is different from the asymmetric encryption key.

15. A computer-implemented method, comprising:
receiving, at a processor of an encryption key management device, an instance of an asymmetric decryption key associated with at least one entity;
sending to an authorized compute device a request for a raw dataset, the raw dataset encrypted with an asymmetric encryption key associated with the asymmetric decryption key;
receiving, from the authorized compute device, the raw dataset in response to the request;
analyzing the raw dataset to identify an association with the at least one entity;
decrypting the raw dataset using the instance of the asymmetric decryption key based on the association of the raw dataset with the at least one entity to generate a decrypted raw dataset;
reencrypting the decrypted raw dataset using a symmetric master key to generate a symmetrically encrypted raw dataset; and
sending the symmetrically encrypted raw dataset to the authorized compute device.

16. The computer-implemented method of claim 15, wherein the instance of the asymmetric decryption key is received from a certification authority compute device.

17. The computer-implemented method of claim 15, wherein the instance of the asymmetric decryption key is associated with a first user compute device and collected by a second user compute device from the first user compute device in a peer-to-peer exchange.

18. The computer-implemented method of claim 15, wherein the instance of the asymmetric decryption key is associated with a first user compute device and collected by a second user compute device from the first user compute device in a peer-to-peer exchange, the instance of the asymmetric decryption key is received from the second user compute device and not the first user compute device.

19. The computer-implemented method of claim 15, wherein the instance of the asymmetric decryption key is associated with a first user compute device and collected by a second user compute device from the first user compute device in a peer-to-peer exchange, the instance of the asymmetric decryption key is received from the second user compute device and not the first user compute device, the peer-to-peer exchange is performed upon a login request to the first user compute device from a user of the first user compute device.

20. The computer-implemented method of claim 15, wherein the instance of the asymmetric decryption key is associated with a first user compute device and collected by a second user compute device from the first user compute device in a peer-to-peer exchange, the instance of the asymmetric decryption key is received from the second user compute device and not the first user compute device, the peer-to-peer exchange is performed upon a login request to the first user compute device from a user of the first user compute device, the at least one entity associated with the raw dataset is the user of the first user compute device.
